(19) United States
(12) Patent Application Publication
(10) Pub. No.: US 2018/0173339 A1
(43) Pub. Date: Jun. 21, 2018

(54) User Equipment

(71) Applicant: Huawei Technologies Co., Ltd., Shenzhen (CN)

(72) Inventors: Jianfei Chu, Beijing (CN); Hui Xie, Shenzhen (CN); Xiaoyang Wang, Beijing (CN); Junqing Shuai, Beijing (CN)

(21) Appl. No.: 15/737,137

(22) PCT Filed: Jun. 19, 2015
(86) PCT No.: PCT/CN2015/081898

§ 371 Date: Dec. 15, 2017

(51) Int. Cl. G06F 3/044; G08B 21/18; H04R 1/02

(52) U.S. Cl. CPC G06F 3/044; G08B 21/182; H04M 1/0202; H04R 2499/11; H04R 1/028

(57) ABSTRACT

A user equipment includes a capacitance detection apparatus, a control unit, a microphone, and a prompt apparatus, where the capacitance detection apparatus includes a touch control unit and a capacitance detection unit. The touch control unit is configured to sense a capacitance change of a touch area in which the touch control unit is located, and the microphone is located in the touch area. The capacitance detection unit is electrically connected to the touch control unit, and the capacitance detection unit measures a capacitance value of the touch area according to the capacitance change sensed by the touch control unit, and sends the capacitance value to the control unit, and the control unit determines whether the capacitance value is greater than or equal to a first preset value, and if yes, determines that the microphone is blocked, and controls the prompt apparatus to send prompt information. In this way, a problem of microphone blocking is thoroughly resolved, making an ongoing voice call smoother.

### CROSS REFERENCE TO RELATED APPLICATION

This application is a U.S. National Stage of International Patent Application No. PCT/CN2015/081898 filed on Jun. 19, 2015, which is hereby incorporated by reference in its entirety.

### TECHNICAL FIELD

Embodiments of present disclosure relate to the field of communications technologies, and in particular, to user equipment.

### BACKGROUND

With constant development of user equipment, people require higher voice call quality. Currently, the user equipment, for example, a smartphone, usually collects a voice using a microphone. The microphone is usually disposed at a lower position on a front side of the user equipment. As a result, the microphone is easily blocked by a finger when people are talking during a voice call, and a voice heard by the other party is relatively low, or even the other party cannot hear a voice clearly.

On the user equipment in other approaches, an expansion groove is disposed at an outer opening of the microphone, which is equivalent to expanding an external opening of a voice transmitting hole of the microphone. By means of such structural reformation, a function of anti-blocking is achieved. However, such structural reformation only reduces a microphone blocking rate, and does not resolve the problem of microphone blocking thoroughly.

### SUMMARY

The present disclosure provides user equipment in order to reliably detect whether a microphone is blocked.

According to a first aspect, an embodiment of the present disclosure provides user equipment, including a capacitance detection apparatus, a control unit, a microphone, and a prompt apparatus, where the capacitance detection apparatus includes a touch control unit and a capacitance detection unit. The touch control unit is configured to sense a capacitance change of a touch area in which the touch control unit is located, and the microphone is located in the touch area. The capacitance detection unit is electrically connected to the touch control unit, and the capacitance detection unit measures a capacitance value of the touch area according to the capacitance change sensed by the touch control unit, and sends the capacitance value to the control unit, and the control unit determines whether the capacitance value is greater than or equal to a first preset value, and if yes, determines that the microphone is blocked, and controls the prompt apparatus to send prompt information.

With reference to the first aspect, in a first possible implementation manner of the first aspect, the user equipment further includes a first connector, where one end of the first connector is connected to the touch control unit using a connection line, and the other end of the first connector is electrically connected to a second connector on a mainboard of the user equipment, and the capacitance detection unit is electrically connected to the second connector.

With reference to the first possible implementation manner of the first aspect, in a second possible implementation manner of the first aspect, the touch control unit, the connection line and the first connector are laid on a flexible circuit board.

With reference to the first aspect or the first possible implementation manner or the second possible implementation manner of the first aspect, in a third possible implementation manner of the first aspect, an open hole is formed on the touch control unit, and the open hole is aligned to a voice transmitting hole of the microphone.

With reference to the first aspect or the first possible implementation manner or the second possible implementation manner of the first aspect, in a fourth possible implementation manner of the first aspect, the touch control unit includes a first touch control part and a second touch control part, and the first touch control part and the second touch control part are disposed facing each other to form an open hole, and the open hole is aligned to a voice transmitting hole of the microphone.

With reference to the fourth possible implementation manner of the first aspect, in a fifth possible implementation manner of the first aspect, the capacitance detection unit is a touchscreen chip, a transmit end of the touchscreen chip is electrically connected to the first touch control part, and a receive end of the touchscreen chip is electrically connected to the second touch control part.

With reference to the first aspect or the first possible implementation manner or the second possible implementation manner or the third possible implementation manner or the fourth possible implementation manner or the fifth possible implementation manner of the first aspect, in a sixth possible implementation manner of the first aspect, the prompt apparatus includes at least one of a speaker, a vibrator or a display screen on the user equipment.

According to a second aspect, an embodiment of the present disclosure provides user equipment, including a switch apparatus, a control unit, a microphone, and a prompt apparatus, where the switch apparatus includes an elastic part and a connecting piece, and the elastic part is disposed on a housing of the user equipment, and the elastic part corresponds to a voice transmitting hole of the microphone. The connecting piece is electrically connected to the control unit. There is a gap between the elastic part and the connecting piece, and when a touch object exerts pressure on the elastic part, the elastic part touches the connecting piece, and a preset level value is generated, and the control unit determines, according to the detected preset level value, that the microphone is blocked, and controls the prompt apparatus to send prompt information.

With reference to the second aspect, in a first possible implementation manner of the second aspect, an open hole is formed on the elastic part, and the open hole is aligned to the voice transmitting hole of the microphone.

With reference to the second aspect or the first possible implementation manner of the second aspect, in a second possible implementation manner of the second aspect, the connecting piece is connected to a general purpose input/output (GPIO) of the control unit using a connection line.

With reference to the second aspect or the first possible implementation manner or the second possible implementation manner of the second aspect, in a third possible implementation manner of the second aspect, the prompt apparatus includes at least one of a speaker, a vibrator or a display screen on the user equipment.

Embodiments of the present disclosure provide user equipment, including a capacitance detection apparatus, a control unit, a microphone, and a prompt apparatus, where the capacitance detection apparatus includes a touch control unit and a capacitance detection unit, the touch control unit is configured to sense a capacitance change of a touch area in which the touch control unit is located, and the microphone is located in the touch area, the capacitance detection unit is electrically connected to the touch control unit, and the capacitance detection unit measures a capacitance value of the touch area according to the capacitance change sensed by the touch control unit, and sends the capacitance value to the control unit, and if the control unit determines that the capacitance value is greater than or equal to a first preset value, the control unit determines that the microphone is blocked, and controls the prompt apparatus to send prompt information. The user equipment determines accurately, according to the measured capacitance value, whether the microphone is blocked, thereby making an ongoing voice call smoother.

### BRIEF DESCRIPTION OF DRAWINGS

To clearly describe technical solutions of embodiments of the present disclosure, the following simply describes accompanying drawings needed to be used in the description of the embodiments. The accompanying drawings in the following descriptions are merely some embodiments of the present disclosure. Other accompanying drawings can be acquired according to these accompanying drawings by a person of ordinary skill in the other approaches without making any creative efforts.

FIG. 1 is a schematic diagram of cooperative use of a capacitance detection apparatus and a microphone according to Embodiment 1 of the present disclosure;

FIG. 2 is a schematic structural diagram of the capacitance detection apparatus according to Embodiment 1 of the present disclosure;

FIG. 3 is a circuit diagram of a capacitance sensing principle according to Embodiment 2 of the present disclosure;

FIG. 4 is a schematic structural diagram of a capacitance detection apparatus according to Embodiment 3 of the present disclosure;

FIG. 5 is a circuit diagram of a principle of sharing a same touchscreen chip according to Embodiment 3 of the present disclosure;

FIG. 6 is a schematic diagram of cooperative use of a switch apparatus and a microphone according to Embodiment 4 of the present disclosure; and

FIG. 7 is a diagram of a principle of detecting microphone blocking using a switch apparatus according to Embodiment 4 of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skills in the art based on the embodiments of the present disclosure without creative efforts fall within the protection scope of the present disclosure.

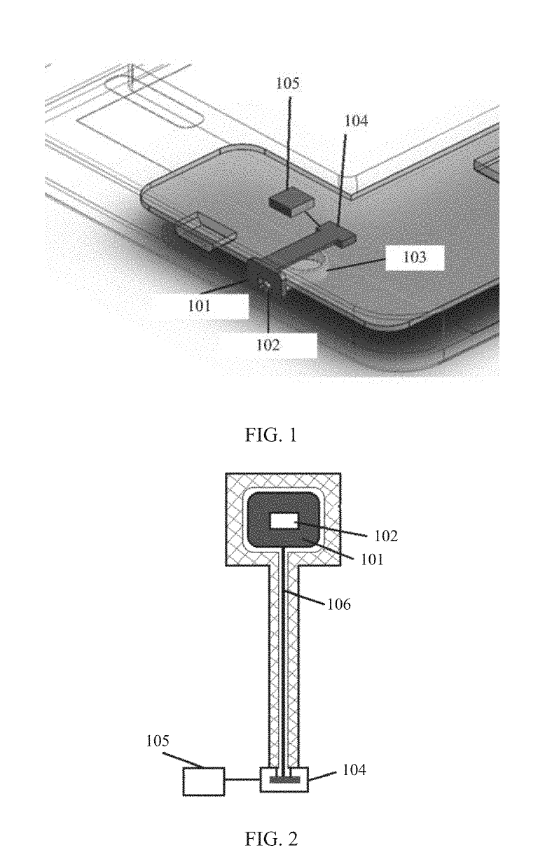

To resolve a problem of microphone blocking on user equipment in the other approaches, the embodiments of the present disclosure provide user equipment. The user equipment is applied to a scenario in which a user uses the user equipment to make a call with a finger, a face or the like blocking a microphone. The user equipment may be a smartphone, a tablet computer or the like. The user equipment includes a capacitance detection apparatus, a control unit, a microphone, and a prompt apparatus. The capacitance detection apparatus includes a touch control unit and a capacitance detection unit. Two ends of the capacitance detection unit are separately electrically connected to the touch control unit and the control unit. FIG. 1 is a schematic diagram of cooperative use of a capacitance detection apparatus and a microphone according to Embodiment 1 of the present disclosure. As shown in FIG. 1, an open hole 102 is formed on a touch control unit 101. The open hole 102 is aligned to a voice transmitting hole of the microphone 103, that is, the touch control unit 101 corresponds to the microphone 103. The touch control unit 101 is electrically connected to a capacitance detection unit 105 using a first connector 104.

The following describes a specific structure of the capacitance detection apparatus.

FIG. 2 is a schematic structural diagram of the capacitance detection apparatus according to Embodiment 1 of the present disclosure. The capacitance detection apparatus includes the touch control unit 101 and the capacitance detection unit 105. Referring to FIG. 1 and FIG. 2, a process of detecting microphone blocking by the capacitance detection apparatus includes that after a finger touches the touch control unit 101, the touch control unit 101 senses a capacitance change of a touch area in which the touch control unit 101 is located. In this case, the capacitance detection unit 105 measures a capacitance value of the touch area according to the capacitance change sensed by the touch control unit 101, and sends the measured capacitance value to the control unit. If the control unit determines that the capacitance value is greater than or equal to a first preset value, the control unit determines that an object has touched the touch control unit 101. Because the microphone 103 is located in the touch area, it indicates that the object has blocked the microphone 103, and the control unit controls the prompt apparatus to send prompt information. Further, as shown in FIG. 2, the touch control unit 101 is electrically connected to the capacitance detection unit 105 using the first connector 104, and a specific connection manner may include that one end of the first connector 104 is connected to the touch control unit 101 using a connection line 106, and the other end of the first connector 104 is electrically connected to a second connector on a mainboard of the user equipment. The open hole 102 is formed on the touch control unit 101. The touch control unit 101, the connection line 106 and the first connector 104 are laid on a flexible circuit board. The capacitance detection unit 105 is electrically connected to the second connector. To reduce parasitic capacitance generated by another connection line, the capacitance detection unit 105 and the flexible circuit board should be as close to each other as possible. Further, because an interference source is formed by a rectangle shape with sharp corners concentrating magnetic fields, the touch control unit 101 provided in this embodiment of the present disclosure is of a rectangle shape with round corners. The touch control unit 101 is connected to the first connector 104 on the flexible circuit board using the connection line 106, and ground wiring processing is performed around using a grid. A double-sided tape is glued on a rear side of the flexible circuit board such that when being installed, the flexible circuit board may be glued on an inner side of a rear housing of a smartphone, and located between a rubber sleeve of a smartphone microphone and the rear housing of the smartphone. In this way, exterior appearance of the smartphone is not affected, a good anti-electrostatic discharge (ESD) capability is achieved, and the touch control unit 101 may correspond to the microphone 103 because the flexible circuit board can be deformed according to a need.

Optionally, the prompt apparatus includes at least one of a speaker, a vibrator or a display screen on the user equipment. Therefore, the prompt information may be correspondingly a voice prompt, a vibration prompt, a text prompt or the like. For example, the voice information may be “Attention, the microphone is blocked.” It should be readily understood that the control unit may be a central processing unit (CPU).

The touch control unit 101 in this embodiment of the present disclosure may be a metallic coil made of a metallic material. For example, the touch control unit 101 may be a copper coil. Connectors configured to transmit currents or signals all may be used as the first connector and the second connector as long as they can connect two active devices. Certainly, another component that can generate a capacitance change, for example, a touchpad, may be used. In addition, the capacitance detection unit 105 may be a chip.

This embodiment of the present disclosure provides the user equipment, including the capacitance detection apparatus, the control unit, the microphone 103, and the prompt apparatus, where the capacitance detection apparatus includes the touch control unit 101 and the capacitance detection unit 105. The touch control unit 101 is configured to sense a capacitance change of a touch area in which the touch control unit 101 is located, and the microphone 103 is located in the touch area. The capacitance detection unit 105 is electrically connected to the touch control unit 101, and the capacitance detection unit 105 measures a capacitance value of the touch area according to the capacitance change sensed by the touch control unit 101, and sends the capacitance value to the control unit, and the control unit determines whether the capacitance value is greater than or equal to a first preset value, and if yes, determines that the microphone is blocked, and controls the prompt apparatus to send prompt information. In this way, a problem of microphone blocking is thoroughly resolved, making an ongoing voice call smoother.

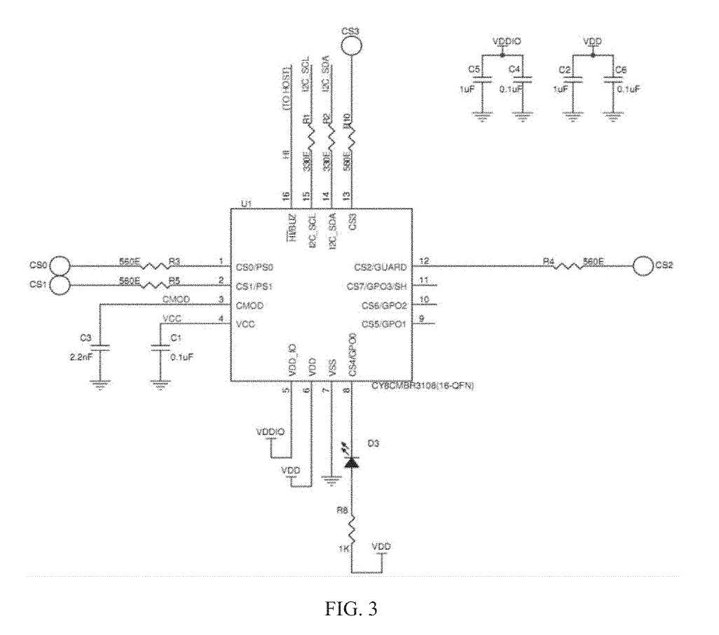

FIG. 3 is a circuit diagram of a capacitance sensing principle according to Embodiment 2 of the present disclosure. A model of a chip in FIG. 3 is CY8CMBR3108(16-QFN). The chip may be used as the capacitance detection unit 105 described in FIG. 1 and FIG. 2. As shown in FIG. 3, CS0, CS1 and CS2 represent touch control units, and are respectively electrically connected to the chip CY8CMBR3108(16-QFN) using pins CS0/PS0, CS1/PS1 and CS2/GUARD. I2C_SCL and I2C_SDA are inter-integrated circuit (I2C) signals in communication with a control unit, and TO_HOST is an interrupt signal in communication with the control unit. When a finger touches the touch control unit CS0, CS1 or CS2, the CY8CMBR3108(16-QFN) measures a capacitance value. When finding that the capacitance value increases, CY8CMBR3108(16-QFN) notifies the control unit using the interrupt signal TO_HOST, and exchanges information with the control unit using an I2C bus, for example, sends the measured capacitance value to the control unit. The control unit determines whether the capacitance value is greater than or equal to a first preset value, and if yes, the control unit controls a prompt apparatus to send prompt information to a user.

Based on the capacitance sensing principle, an embodiment of the present disclosure further provides a capacitance detection apparatus, and details are as follows.

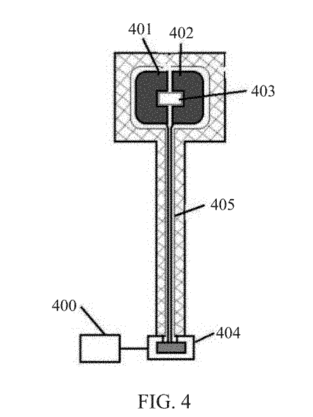

FIG. 4 is a schematic structural diagram of a capacitance detection apparatus according to Embodiment 3 of the present disclosure. As shown in FIG. 4, the capacitance detection apparatus includes a touch control unit and a capacitance detection unit 400. The touch control unit includes a first touch control part 401 and a second touch control part 402. The first touch control part 401 and the second touch control part 402 are disposed facing each other to form an open hole 403. The open hole 403 is aligned to a voice transmitting hole of a microphone. Further, the capacitance detection unit 400 may be a touchscreen chip. A transmit end of the touchscreen chip is electrically connected to the first touch control part 401, and a receive end of the touchscreen chip is electrically connected to the second touch control part 402. Cooperative use of the capacitance detection apparatus and the microphone is similar to that shown in FIG. 1. The first touch control part 401 and the second touch control part 402 are configured to sense a capacitance change of a touch area. One end of a first connector 404 is connected to the first touch control part 401 and the second touch control part 402 using two connection lines 405, and the other end of the first connector 404 is electrically connected to a second connector on a mainboard of the user equipment. The first touch control part 401, the second touch control part 402, the first connector 404 and the two connection lines 405 are laid on a flexible circuit board. The capacitance detection unit 400 is electrically connected to the second connector. The capacitance detection unit 400, that is, the touchscreen chip, includes at least one transmit (TX) end and at least one receive (RX) end. The TX end is connected to the first touch control part 401 using the second connector, the first connector 404 and a connection line 405 in sequence, and the RX end is connected to the second touch control part 402 using the second connector, the first connector 404 and a connection line 405 in sequence. The TX end and the RX end are independent from other TX ends and RX ends of the touchscreen chip.

The first touch control part 401 and the second touch control part 402 in this embodiment of the present disclosure may be made of metal wires, and may be each made into a semicircle shape such that the open hole 403 formed is between them. Similarly, other components that can generate a capacitance values may be used. Connectors configured to TX currents or signals all may be used as the first connector 404 and the second connector as long as they can connect two active devices. The connection lines may be copper wires.

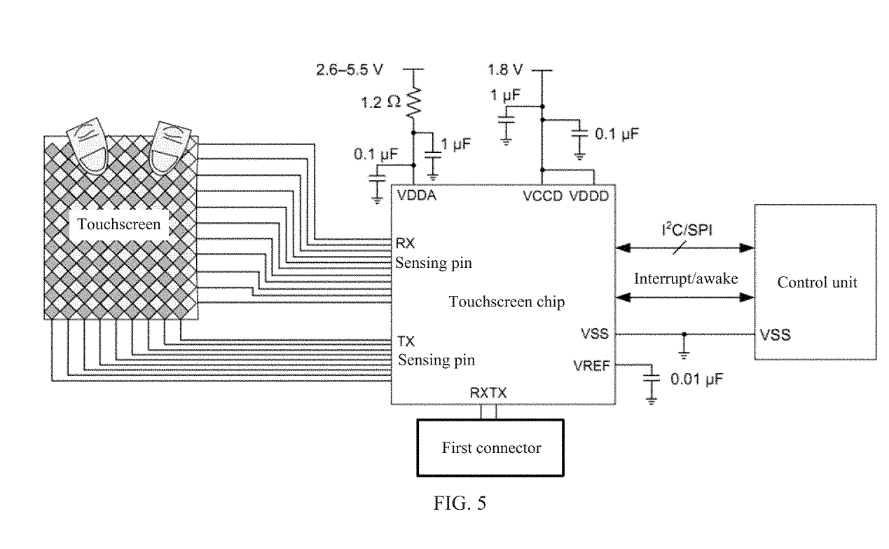

This embodiment of the present disclosure provides the capacitance detection apparatus, including the first touch control part 401, the second touch control part 402 and the capacitance detection unit 400. There is the open hole 403 between the first touch control part 401 and the second touch control part 402, and the open hole 403 is aligned to a voice transmitting hole of a microphone. Once the voice transmitting hole is blocked by an object, the capacitance detection unit 400 detects that a capacitance value of a position in which the microphone is located increases. In this case, a touchscreen chip sends the measured capacitance value to a control unit. The control unit determines, according to the capacitance value, whether the microphone is blocked, and if yes, the control unit controls a prompt apparatus to prompt a user that the microphone is blocked. Therefore, a problem of microphone blocking is resolved, making an ongoing voice call smoother. A main difference between the capacitance detection apparatus shown in FIG. 4 and the capacitance detection apparatus shown in FIG. 2 is that the capacitance detection apparatus shown in FIG. 4 may not be separately provided with a capacitance detection unit, and but share a same chip, that is, a touchscreen chip, with a smartphone touchscreen. The touchscreen chip uses a mutual capacitance principle. Because the touchscreen chip includes multiple RX ends and TX ends, in design of the touchscreen, one RX end and one TX end of the touchscreen chip may be reserved for microphone anti-blocking detection. FIG. 5 is a circuit diagram of a principle of sharing a same touchscreen chip according to Embodiment 3 of the present disclosure. As shown in FIG. 5, an RX end and a TX end of the touchscreen chip are connected to a first connector of a capacitance detection apparatus. With reference to FIG. 4, the first connector is connected to a first touch control part and a second touch control part using connection lines, and electrical connections between the first touch control part and the touchscreen chip and between the second touch control part and the touchscreen chip are eventually implemented.

In all of the foregoing embodiments, whether a microphone is blocked by a finger is detected according to a capacitance change. When the finger touches the microphone, the finger and a touch control unit form a simple parallel-plate capacitor. If parasitic capacitance of a capacitance detection apparatus is Cp, and finger capacitance is Cf, when the microphone is not blocked by the finger, total capacitance of the touch control unit is Cx=Cp, and when the microphone is blocked by the finger, the total capacitance of the touch control unit is Cx=Cp+Cf. Therefore, the capacitance detection apparatuses in the foregoing embodiments all detect whether a microphone is blocked according to a capacitance change.

Embodiment 4 of the present disclosure provides user equipment. The user equipment includes a switch apparatus, a control unit, a microphone, and a prompt apparatus. The switch apparatus includes an elastic part and a connecting piece. The elastic part is disposed on a housing of the user equipment, and the elastic part corresponds to a voice transmitting hole of the microphone. The connecting piece is electrically connected to the control unit. There is a gap between the elastic part and the connecting piece. When a touch object exerts pressure on the elastic part, the elastic part touches the connecting piece because of elastic deformation, and a preset level value “0” is generated. The control unit determines, according to the detected preset level value, that the microphone is blocked, and controls the prompt apparatus to send prompt information. Optionally, the prompt apparatus includes at least one of a speaker, a vibrator or a display screen on the user equipment. Therefore, the prompt information may be correspondingly a voice prompt, a vibration prompt, a text prompt or the like.

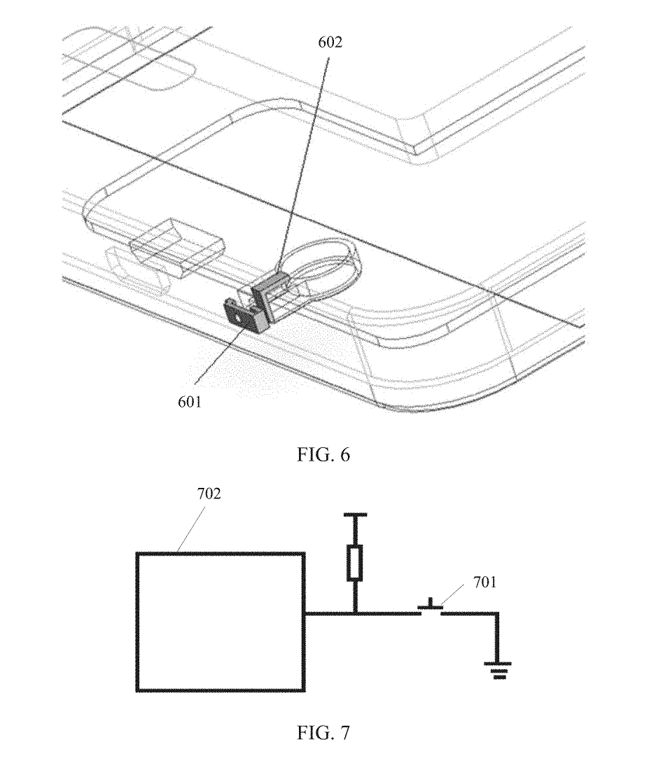

Further, FIG. 6 is a schematic diagram of cooperative use of the switch apparatus and the microphone according to Embodiment 4 of the present disclosure. As shown in FIG. 6, the switch apparatus includes an elastic part 601 and a connecting piece 602. An open hole is formed on the elastic part 601, and the open hole is aligned to the voice transmitting hole of the microphone. The elastic part 601 is fastened to a housing of the user equipment, and can be grounded reliably using the housing. The connecting piece 602 is disposed on a mainboard of the user equipment, and is connected to a GPIO of the control unit using a connection line. The elastic part 601 may be a metallic elastic part, for example, an elastic part made of copper. The connecting piece 602 may be a metallic connecting piece, for example, a connecting piece made of copper. FIG. 7 is a diagram of a principle of detecting microphone blocking using a switch apparatus according to Embodiment 4 of the present disclosure. As shown in FIG. 7, a switch apparatus 701 has one end grounded using a housing, and the other end connected to a GPIO of a control unit 702. When the switch apparatus 701 is pressed down, that is, an elastic part touches a connecting piece, an entire circuit is grounded, that is, a voltage on the circuit is 0 V, and a corresponding logical level value is “0.” In this case, the control unit 702 determines, according to the detected preset level value, that a microphone is blocked, and controls a prompt apparatus to send prompt information to a user.

It should be noted that the control unit 702 in this embodiment of the present disclosure may be a CPU.

This embodiment of the present disclosure provides user equipment, including the switch apparatus 701, the control unit 702, the microphone, and the prompt apparatus, where when the microphone is blocked by a finger, the elastic part touches the connecting piece, and the control unit 702 determines, according to a detected preset level value, that the microphone is blocked, and controls a prompt apparatus to send prompt information to a user, thereby making an ongoing voice call smoother.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

1. A user equipment, comprising:
a capacitance detection apparatus comprising a touch controller and a capacitance detector;
a controller electrically coupled to the capacitance detector;
a microphone coupled to the controller; and
a prompt apparatus coupled to the controller,
wherein the touch controller is configured to sense, during an ongoing voice call, a capacitance change of a touch area in which the touch controller is located,
wherein the microphone is located in the touch area,
wherein the capacitance detector is configured to:
measure a capacitance value of the touch area according to the capacitance change sensed by the touch controller; and
send the capacitance value to the controller, and
wherein the controller is configured to:
determine that the microsphone is blocked when the capacitance value is greater than or equal to a first preset value; and
control the prompt apparatus to send prompt information to indicate that the microphone is blocked.

2. The user equipment according to claim 1, further comprising a first connector, wherein one end of the first connector is coupled to the touch controller using a connection line, wherein the other end of the first connector is electrically coupled to a second connector on a mainboard of the user equipment, and wherein the capacitance detector is electrically coupled to the second connector.

3. The user equipment according to claim 2, wherein the touch controller, the connection line and the first connector are disposed on a flexible circuit board.

4. The user equipment according to claim 1, wherein an open hole is formed on the touch controller, and wherein the open hole is aligned to a voice transmitting hole of the microphone.

5. The user equipment according to claim 1, wherein the touch controller comprises a first touch control part and a second touch control part, wherein the first touch control part and the second touch control part are disposed facing each other to form an open hole, and wherein the open hole is aligned to a voice transmitting hole of the microphone.

6. The user equipment according to claim 5, wherein the capacitance detector comprises a touchscreen chip, wherein a transmit end of the touchscreen chip is electrically coupled to the first touch control part, and wherein a receive end of the touchscreen chip is electrically coupled to the second touch control part.

7. The user equipment according to claim 1, wherein the prompt apparatus comprises a speaker of the user equipment.

8. A user equipment, comprising:
a switch comprising an elastic part and a connecting piece;
a controller coupled to the switch;
a microphone coupled to the switch and the controller; and
a prompt apparatus coupled to the switch, the controller, and the microphone,
wherein the elastic part is disposed on a housing of the user equipment and corresponds to a voice transmitting hole of the microphone,
wherein the connecting piece is electrically coupled to the controller,
wherein a gap is between the elastic part and the connecting piece,
wherein the elastic part is configured to:
touch the connecting piece when a touch object exerts pressure on the elastic part; and
generate a preset level value, and
wherein the controller is configured to:
determine, during an ongoing voice call, that the microphone is blocked according to the detected preset level value; and
control the prompt apparatus to send prompt information to indicate that the microphone is blocked.

9. The user equipment according to claim 8, wherein an open hole is formed on the elastic part, and wherein the open hole is aligned to the voice transmitting hole of the microphone.

10. The user equipment according to claim 8, wherein the connecting piece is coupled to a general purpose input/output (GPIO) of the controller using a connection line.

11. The user equipment according to claim 8, wherein the prompt apparatus comprises a speaker of the user equipment.

12. The user equipment according to claim 1, wherein the prompt apparatus comprises a vibrator of the user equipment.

13. The user equipment according to claim 1, wherein the prompt apparatus comprises a display screen of the user equipment.

14. The user equipment according to claim 8, wherein the prompt apparatus comprises a vibrator of the user equipment.

15. The user equipment according to claim 8, wherein the prompt apparatus comprises a display screen of the user equipment.

16. The user equipment according to claim 1, wherein the prompt information comprises a voice prompt.

17. The user equipment according to claim 1, wherein the prompt information comprises at least one of a vibration prompt or a text prompt.

18. The user equipment according to claim 8, wherein the prompt information comprises at least one of a voice prompt, a vibration prompt, or a text prompt.

19. A prompting method executed by a device comprising a microphone, comprising:
sensing, by the device during an ongoing voice call, a capacitance change of a touch area in which the microphone is located;
measuring, by the device, a capacitance value of the touch area according to the sensed capacitance change; and
sending, by the device, prompt information to indicate that the microphone is blocked when the capacitance value is greater than or equal to a first preset value.

20. The method according to claim 19, wherein the prompt information comprises at least one of a voice prompt, a vibration prompt, or a text prompt.
